(19) United States
(12) Patent Application Publication
(10) Pub. No.: US 2009/0322703 A1
(43) Pub. Date: Dec. 31, 2009

(54) Touch panel with touch pads

(75) Inventors: Cheng-Te Tseng, Taipei City (TW); Chang-Hung Lee, Yunlin County (TW); Chieh-Yuan Cheng, Taoyuan City (TW)

Correspondence Address: COVENANT IP CONSULTING CO., P.O. BOX 34-306 TAIPEI CITY, TAIPEI, 10499, TW

(73) Assignee: QISDA CORPORATION, Taoyuan Shien (TW)

(21) Appl. No.: 12/479,770

(22) Filed: Jun. 6, 2009

(30) Foreign Application Priority Data
Jun. 26, 2008 (TW) 97123912

(51) Int. Cl. G06F 3/045

(52) U.S. Cl. 345/174

(57) ABSTRACT

A touch panel with touch pads includes a transparent substrate, a transparent electrode and a plurality of conductive lines. The transparent substrate has a display region. The transparent electrode is disposed on the transparent substrate and has a plurality of first touch blocks and a second touch block. The first touch blocks are disposed along the edges of the display region. The second touch block is disposed within the region surrounded by the first touch blocks and has an extending block passing through a gap between the first touch blocks and extending to the edge of the display region. The conductive lines are disposed outside the display region and electrically connected to the first touch blocks and the extending block adjoining the edges of the display region.

This application claims the benefit of Taiwan application Serial No. 0 97123912, filed Jun. 26, 2008, the subject matter of which is incorporated herein by reference.

### BACKGROUND OF THE INVENTION

1. Field of the Invention

The invention relates to a touch panel, and more specifically to the touch panel with touch pads.

2. Description of the Related Art

Touch panel is primarily adopted resistance type touch panel and capacitance type touch panel in electronic apparatus. These two types are primarily based on two pieces of conductive transparent substrate.

The resistance type touch panel can derive the characteristic of x-y coordination in accordance with the bottom conductive transparent substrate. When the user touches a specific location of the touch panel, a specific resistance value is caused to generate a specific analog voltage signal. The analog voltage signal is then converted into a digital signal and further transmitted to a control unit. The control unit receives and processes the signal to generate x-y coordination value. The capacitance type touch panel is generated a uniform electric field on the surface of touch panel. Therefore, when the touch panel is pressurized, a capacitance value is changed at the pressurized point. Then, a specific analog current or voltage signal is generated corresponding to the capacitance value. The analog current or voltage signal is then converted into a digital signal and further transmitted to a control unit. The control unit receives and processes the signal to generate x-y coordination value.

These two type touch panels, mentioned above, accurately detect the position where a user touched for generating a detected signal. The control unit processes a complicate calculation for generating x-y coordination value. In addition, the structure of these two type touch panels is also complicate.

### SUMMARY OF THE INVENTION

The present invention is related to a touch panel with touch pads, which directly covers a single layer transparent electrode on a transparent substrate. The present invention provides the advantage of simple structure, and may provide high reliability at a relatively low cost.

The present invention provides the touch panel with touch pads. The touch panel comprises a transparent substrate, a transparent electrode and conductive lines. The transparent substrate comprises a display region. The transparent electrode is disposed on the transparent substrate and has a plurality of first touch blocks and a second touch block, wherein the first touch blocks are disposed along the edges of the display region, and the second touch block is disposed within a region surrounded by the first touch blocks and has an extending block passing through a gap between the first touch blocks and extending to the edge of the display region. The conductive lines are disposed outside the display region, and connected to the first touch blocks and the first extending block adjoining the edges of the display region.

The present invention further provides the touch panel with touch pads. The touch panel comprises a transparent substrate, a plurality of first transparent electrode touch blocks, a second transparent electrode touch block and conductive lines. The transparent substrate comprises a display region. The first transparent electrode touch blocks are disposed along at least one the edge of the display region, and the second transparent electrode touch block having a main touch block and a first extending block, wherein the main touch block is disposed at a region far away from the the edge of the display region, and the first extending block extends to the edge of the display region and is connected to the main touch block. The conductive lines are disposed outside the display region, and connected to the first touch blocks and the first extending block adjoining the edges of the display region.

The invention will become apparent from the following detailed description of the preferred but non-limiting embodiments. The following description is made with reference to the accompanying drawings.

### BRIEF DESCRIPTION OF THE DRAWINGS

FIG. 1A is a touch panel according to an embodiment of the present invention;

FIG. 1B is a schematic illustration of the partial FIG. 1A according to an embodiment of the present invention;

FIG. 2 illustrates a part of first touch blocks separating a distance between the first touch blocks according to an embodiment of the present invention;

FIG. 3 is schematic illustration of the first touch blocks disposed along the partial edges of a display region according to an embodiment of the present invention;

FIG. 4 illustrates the touch panel including a circular touch block according to an embodiment of the present invention;

### DETAILED DESCRIPTION OF THE INVENTION

Contrary to the conventional touch panel utiliting two pieces of conductive transparent substrate, the present invention directly covers a single layer transparent electrode, such as indium tin oxide (ITO), on a transparent substrate. According to isolating predetermined position on the transparent electrode, independent touch blocks are capable of outputting a signal to a control unit when touched (triggered). Therefore, the touched block will be detected. There are several embodiments to describe the present invention below.

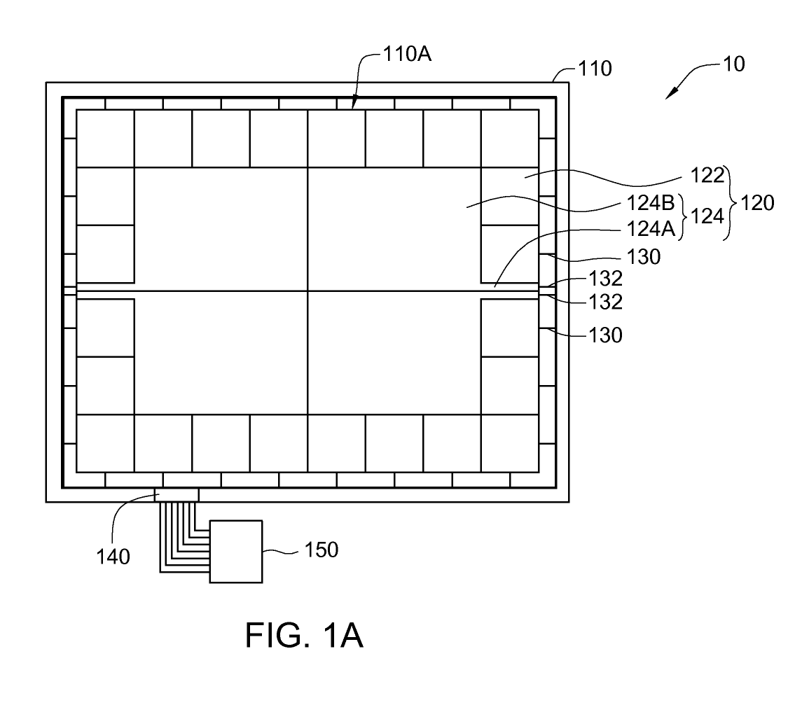

Referring to FIGS. 1A & 1B, FIG. 1A illustrates schematically, at 10, a touch panel. FIG. 1B illustrates schematically partial touch panel in FIG. 1A. The touch panel 10 includes a transparent substrate 110, a transparent electrode 120, a plurality of first conductive lines and a second conductive line. The transparent substrate 110 covered with a transparent electrode 120 has a display region 110A. The transparent electrode 120 has a plurality of first touch blocks 122 and a second touch block 124 which are configured to generate touch pads. The first touch blocks 122 are disposed along the edges of the display region 110A, and the second touch block 124 is disposed within a region surrounded by the first touch blocks 122 and far away from the the edge of the display region 110A. The touch panel 10 can be implement in a digial photo frame. When the digial photo frame is in a displaying mode, the display region 110A can display an image with a full screen size on the area of the first touch blocks 122 and the second touch blocks 124. When the digial photo frame is in a setting mode, the image can be display only on the area of the second touch blocks 124 and other setting function icons can be display on the area of the first touch blocks 122 respectively.

For purpose of producing the first touch blocks 122 and the second touch block 124, the transparent electrode 120 is formed on the transparent substrate 110, and then it may etch the transparent electrode 120 in accordance with predetermined edges of the touch blocks (122 & 124), which is configured to be touch pads. In a preferred embodiment, the etching width should be smaller than the width of identification by viewer. In addiction, the conductive lines 130 and 132 are easy to identify by viewer. Therefore, the conductive lines 130 and 132 are disposed outside the display region 110A in which avoiding appearance of the conductive lines 130 and 132, wherein the conductive lines 130 is connected to the first touch blocks 122 respectively, and the conductive line 132 is connected to the second touch block 124.

As illustrated in FIG. 1A, the touch panel further comprises a transmission interface 140. The conductive lines 130 and 132 are disposed outside the display region 110A and gathered together to the transmission interface 140. The conductive lines 130 and 132 are electrically connected to a controlling unit 150 through the transmission interface 140, such as a capacitive touch switching integrated circuit. The capacitance of the touch block is changed when finger touches the touch block, such as the first touch blocks 122 and the second touch block 124, meanwhile, the triggered touch block provides a contact signal to the controlling unit 150 through the conductive line (130 or 132) and the transmission interface 140. Thus, the controlling unit 150 can detect the position of the triggered touch block.

As illustrated in FIG. 1A, the display region 110A comprises four second touch blocks 124 are disposed surrounded by the first touch blocks 122, the area of the second touch block 124 is large than the area of one of the first touch blocks 122, and the first touch blocks 122 and the second touch block 124 are substantially covered entire the display region 110A. The first touch blocks 122 can also cover a portion area outside the display region 110A. Thus, the entire display region 110A is effective touch region. The second touch block 124 is located in the interior of the display region 110A. Therefore, for connecting to the conductive line 132, the second touch block 124 extends an extending block 124A, which passes through a gap between two of the first touch blocks 122 and extends to the edge of the display region 110A.

As illustrated in FIG. 1B, the extending block 124A is close to the first touch blocks 122, so it is easy to mis-touch the extending block 124A when a user touched one of the first touch blocks 122. For preventing “mis-touch” mentioned above, the width of the extending block 124A or a gap (W1) between the first touch blocks 122 should be as small as possible to reduce the effective contact area. Preferably, the width of the extending block 124A or a gap (W1) between the first touch blocks 122 is smaller than half the thickness of the transparent substrate 110 or 30 μm.

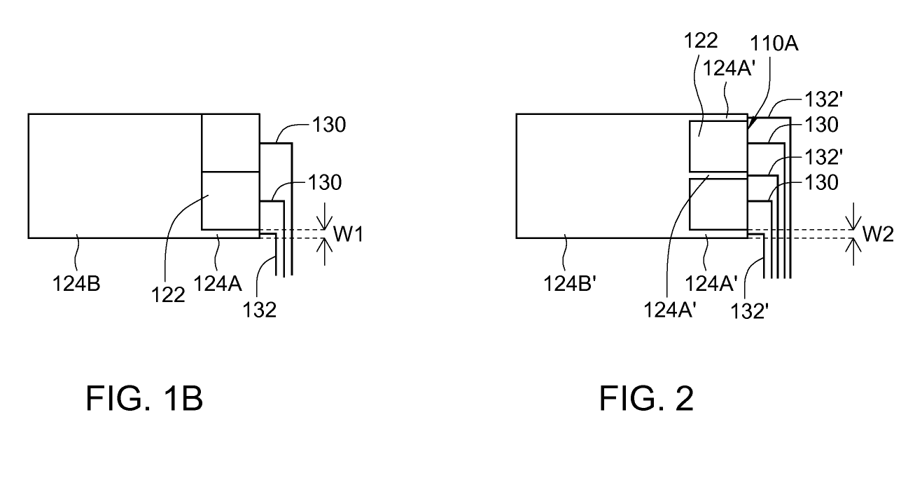

It should be appreciated that when reducing the width of the extending block 124A, the resistance between the extending block 124A and the conductive line 132 will increase. Therefore, the detecting sensitivity of the controlling unit 150 will decline when a user touches the touch blocks. In order to solve the problem mentioned above, the conductive line 132 connected to the second touch block 124 can be increased to decreasing the resistance mentioned above. FIG. 2 illustrates schematically to show a partial portion of the first touch blocks 122 in FIG. 1A. Also referring to FIG. 2, the first touch blocks 122 adjecent to the edge of the display region 110A has a plurality of gaps W2. The second touch block 124′ has a plurality of extending blocks 124A′ passing through the gaps W2 respectively for connecting to the conductive lines 132′ at the edge of the display region 110A. One of the width of gaps W2 or the width of the extending blocks 124A′ are smaller than the width of gap W1, so the width of a conductive line 132′ connecting to the extending blocks 124A′ is smaller than the width of the conductive line 132 and the width of each of the conductive lines 130. Still referring to FIG. 2, for example, the width of a conductive line 132′ is smaller than one third of the width of the conductive line 130. Thus, as described above, the transverse area of the conductive line 132′ connecting to the extending blocks 124A′ is decreasing, and then results in increase of the resistance between the extending block 124A′ and the conductive line 132′. Therefore, the detecting sensitivity of the controlling unit 150 will reduce when a user touch the touch blocks. In order to solve the problem mentioned above, three the conductive lines 132′ connected to three extending blocks 124A′ respectively to maintain the detecting sensitivity of the controlling unit 150.

Although described above in regards to the first touch blocks 122 and at least one the second touch block 124 (or 124′) substantially covered all the display region 110A, it should be appreciated that the amount, the area and the configuration of the touch blocks (122 and 124) practically may be determined in accordance with design of product.

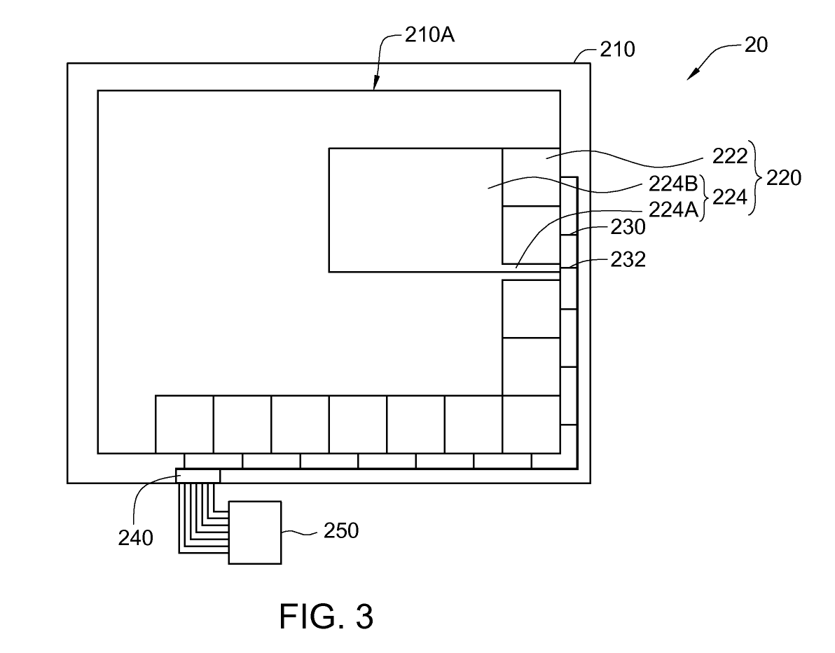

Referring to FIG. 3, in some embodiment, the first touch blocks 222 are disposed along the partial edges of the display region 210A. The touch panel 20 different from the touch panel 10 is that the transparent substrate 210 is partially covered by the transparent electrode 220, wherein the first touch blocks 222 with the transparent electrode 220 are disposed along the partial edges of the display region 210A (as shown the bottom/right edge of the display region 210A in FIG. 3). The partial display region 210A of the touch panel 20 is effective touch area by disposing at least one the second touch block 224, at the interior of the display region 210A, and the first touch blocks 222. In addiction, the conductive lines 230 and 232 are disposed outside and along the display region 210A. The first touch blocks 222 are connected to the conductive lines 230 respectively. The second touch block 224 includes a main touch block 224B and an extending block 224A, wherein the main touch block 224B is connected to the conductive line 232 through the extending block 224A. The first touch blocks 222 and the second touch block 224 are connected to the transmission interface 240 and the controlling unit 250 through the conductive lines 230 and 232 respectively.

However, the first touch blocks 122/222 and the second touch block 124/124′/224 are rectangular shape, as an example, but are not limited to. It should be appreciated that the touch block may be circular shape, ellipse, polygon or any irregular shape. Additionally, the touch block also may be designed in accordance with the size of the display region and the position of touch pad.

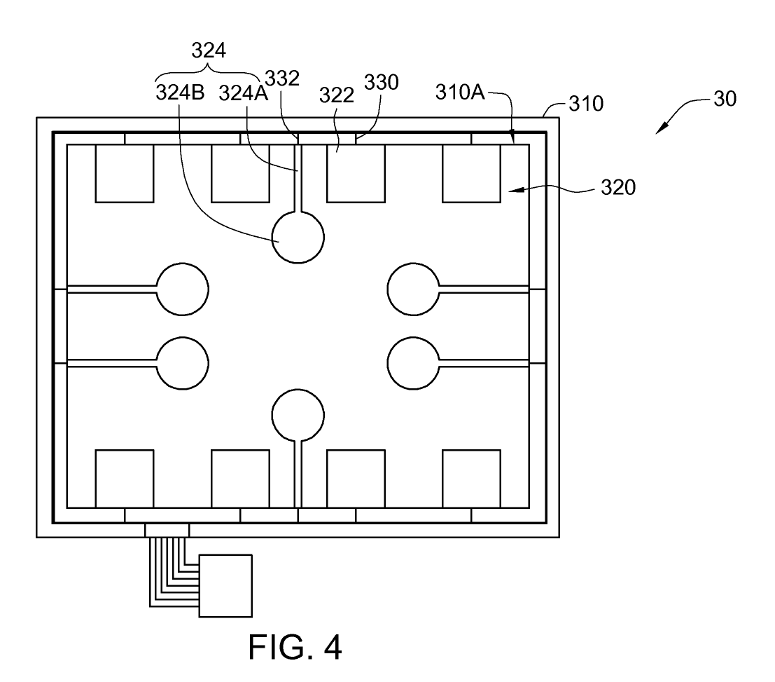

Referring to FIG. 4, it shows an example that the touch block is designed as circular shape. The partial transparent substrate 310 of the display region 310A is covered with the transparent electrode 320. In order to achieve the object mentioned above, for example, it may be covered with the transparent electrode 320 on the transparent substrate 310 and then etch the transparent electrode 320 in addition to the touch blocks. Alternatively, it may be only covered with the transparent electrode 320 on the transparent substrate 310 in accordance with the touch blocks. The transparent electrode 320 comprises the first touch blocks 322 and the second touch blocks 324, wherein some or all of the first touch blocks 322 may be designed as rectangular shape, and some or all of the second touch blocks 324 may be designed as circular shape. The first touch blocks 322 are not continuously disposed along the edges of the display region 310A. One of second touch blocks 224, for example, includes a main touch block 324B and an extending block 324A, wherein the main touch block 324B is disposed at a region far away from the the edge of the display region 310A, and the extending block 324A extends to the edge of the display region 310A and is connected to the main touch block. The first touch blocks 322 and the extending block 324A are respectively connected to the conductive lines (330 and 332) disposed outside the display region 310A.

It is possible to diversify the touch pad by designing the touch block, which applies to the electronic apparatus of touch panel, such as a digital photo frame. Moreover, it is also possible to diversify operation UI (user interface) by displaying configuration on the display region.

The touch panel with touch pads disclosed in the present invention is that the single layer transparent electrode is directly defined the position of touch pads. Accordingly, the touch panel is entirely or partially formed the effective contact area. Touch pads, located in the edge and the interior of the display region, are cooperated with configuration displaying on the display region to generate operation UI (user interface). Contrary to the conventional touch panel utiliting two-layer transparent electrode, the present invention is simple in the structure and the production. Moreover, the present invention doesn't cooperate with complicated driving circuit and/or algorithm to detect the position of the triggered touch pad, which will save more cost.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A touch panel, comprising:
a transparent substrate having a display region;
a transparent electrode disposed on the transparent substrate comprising:
a plurality of first touch blocks disposed along edges of the display region; and
a second touch block surrounded by the first touch blocks and having an extending block passing through a first gap between two of the first touch blocks which located at the same edge of the display region and the first gap extending to the edge of the display region;
a plurality of first conductive lines disposed outside the display region and electrically connected to the first touch blocks adjoining the edges of the display region; and
a second conductive line disposed outside the display region and electrically connected to the first extending block adjoining the edges of the display region.

2. The touch panel according to claim 1, wherein the second touch block further comprises a second extending block passing through a second gap between two of the first touch blocks and extending to the edge of the display region.

3. The touch panel according to claim 2, further comprising:
a third conductive line disposed outside the display region and electrically connected to the second extending block adjoining the edges of the display region;
wherein the width of the third conductive line and the width of the second conductive line are smaller than the width of the first conductive line.

4. The touch panel according to claim 3, wherein the width of the third conductive line and the width of the second conductive line are smaller than one third of the width of the first conductive line.

5. The touch panel according to claim 1, wherein the display region is substantially covered by the first touch blocks and the second touch block.

6. The touch panel according to claim 1, wherein the first gap between the the first touch blocks is smaller than half the thickness of the transparent substrate.

7. The touch panel according to claim 1, wherein the first gap is smaller than 30 μm.

8. The touch panel according to claim 1, further comprising:
a transmission interface connected to the first conductive lines and the second conductive line.

9. A touch panel, comprising:
a transparent substrate having a display region;
a plurality of first transparent electrode touch blocks and a second transparent electrode touch block disposed on the transparent substrate, wherein the first transparent electrode touch blocks are disposed along at least one the edge of the display region, and the second transparent electrode touch block comprising a main touch block and a first extending block, wherein the main touch block is disposed far away the edge of the display region, and the first extending block extends to the edge of the display region and connected to the main touch block;
a plurality of first conductive lines disposed outside the display region and respectively connected to the first transparent electrode touch blocks adjoining the edges of the display region; and
a second conductive line disposed outside the display region and electrically connected to the first extending block adjoining the edges of the display region.

10. The touch panel according to claim 9, wherein the first extending block passes through a gap between two of the first transparent electrode touch blocks and extends to the edge of the display region.

11. The touch panel according to claim 9, the second transparent electrode touch block further comprising a second extending block, the first extending block and the second extending block respectively pass through two different gaps among the first transparent electrode touch blocks and extend to the edge of the display region.

12. The touch panel according to claim 11, further comprising:
a third conductive line electrically connected to the second extending block adjoining the edges of the display region
wherein the width of the third conductive line and the width of the second conductive line are smaller than the width of the first conductive line.

13. The touch panel according to claim 12, wherein the width of the third conductive line and the width of the second conductive line are smaller than one third of the width of the first conductive line.

14. The touch panel according to claim 9, wherein the display region is substantially covered by the first transparent electrode touch blocks and the second transparent electrode touch block.

15. The touch panel according to claim 9, wherein the gap between the the first transparent electrode touch blocks is smaller than half the thickness of the transparent substrate.

16. The touch panel according to claim 9, wherein the gap between the the first transparent electrode touch blocks is smaller than 30 μm.

17. The touch panel according to claim 9, further comprising:
a transmission interface connected to the first conductive lines and the second conductive line.

18. A touch panel, comprising:
a transparent substrate having a display region;
a transparent electrode disposed on the transparent substrate comprising:
a first touch block;
a second touch block, the first touch block and the second touch block disposed adjacent and along a first edge of the display region; and
a third touch block disposed adjacent to the first touch block and the second touch block, the third touch block comprising a first extending block passing through a first gap between the first touch block and the second touch block.

19. The touch panel according to claim 18, the transparent electrode further comprising:
a fourth touch block, wherein the third touch block further comprising a second extending block passing through a second gap between the first touch block and the fourth touch block.

20. The touch panel according to claim 18, the transparent electrode further comprising:
a fourth touch block; and
a fifth touch block, wherein the third touch block further comprising a second extending block passing through a second gap between the fourth touch block and the fifth touch block.
